(19) United States
(12) Patent Application Publication
(10) Pub. No.: US 2015/0185390 A1
(43) Pub. Date: Jul. 2, 2015

(54) LIGHT SOURCE MODULE

(71) Applicant: HON HAI PRECISION INDUSTRY CO., LTD., New Taipei (TW)

(72) Inventors: CHAU-JIN HU, Tu-Cheng (TW); FENG-YUEN DAI, Tu-Cheng (TW); YUNG-LUN HUANG, Tu-Cheng (TW)

(73) Assignee: HON HAI PRECISION INDUSTRY CO., LTD., New Taipei (TW)

(21) Appl. No.: 14/525,476

(22) Filed: Oct. 28, 2014

(30) Foreign Application Priority Data
Dec. 31, 2013 (TW) 102149184

(51) Int. Cl. F21V 8/00; G02B 1/00; F21K 99/00

(52) U.S. Cl. CPC G02B 6/0008; F21K 9/52; G02B 1/00; F21Y 2101/02

(57) ABSTRACT

A light source module includes a light source, a fixing plate, a plurality of fibers and a plurality of light diverging elements. The light source includes a light outputting surface. The fixing plate is arranged above the light emitting surface of the light source. Each fiber includes a light inputting end which is optically coupled to the light emitting surface and a light outputting end opposite to the light inputting end. Each of the light outputting ends is inserted into the fixing plate. A distance between each two adjacent light outputting ends is greater than the distance between each two adjacent light inputting ends. The light diverging elements are arranged on the fixing plate, and cover the light output surface of fiber.

### FIELD

The subject matter herein generally relates to a light source module.

### BACKGROUND

LEDs have low power consumption, high efficiency, quick reaction time, long lifetime, and the absence of toxic elements such as mercury during manufacturing. Due to those advantages, traditional light sources are gradually replaced by LEDs.

A conventional LED light source generally generates a smooth round light field with a radiation angle of 120 degrees (−60 degrees to 60 degrees), wherein the light intensity is concentrated at a center of the conventional LED (i.e., 0 degree). The intensity of light emitted by the conventional LED is unevenly distributed, and will dramatically decrease when the radiation angle is beyond the range of 120 degrees. Such that a lens is usually provided to engage with the conventional LED for making the light intensity evenly distributed. However, the intensity of light at the center of the conventional LED will be still easily greater than that of located at a periphery of the conventional LED when the light emitted by the conventional LED is sufficiently distributed. As such, the light emitted by the LED light source is unevenly distributed, and thereby a whole light output of the LED light source is barely satisfactory for illumination.

### BRIEF DESCRIPTION OF THE DRAWINGS

Implementations of the present technology will now be described, by way of example only, with reference to the attached figures.

FIG. 1 is a cross-sectional view of a light source module in accordance with an exemplary embodiment of the present disclosure.

FIG. 2 is an enlarged cross-sectional view of a light diverging element in the light source module of FIG. 1.

FIG. 3 is a diagrammatic view showing an optical spectrum of a traditional light source module without having light diverging elements.

FIG. 4 is a diagrammatic view showing an optical spectrum of the light source module of FIG. 1.

### DETAILED DESCRIPTION

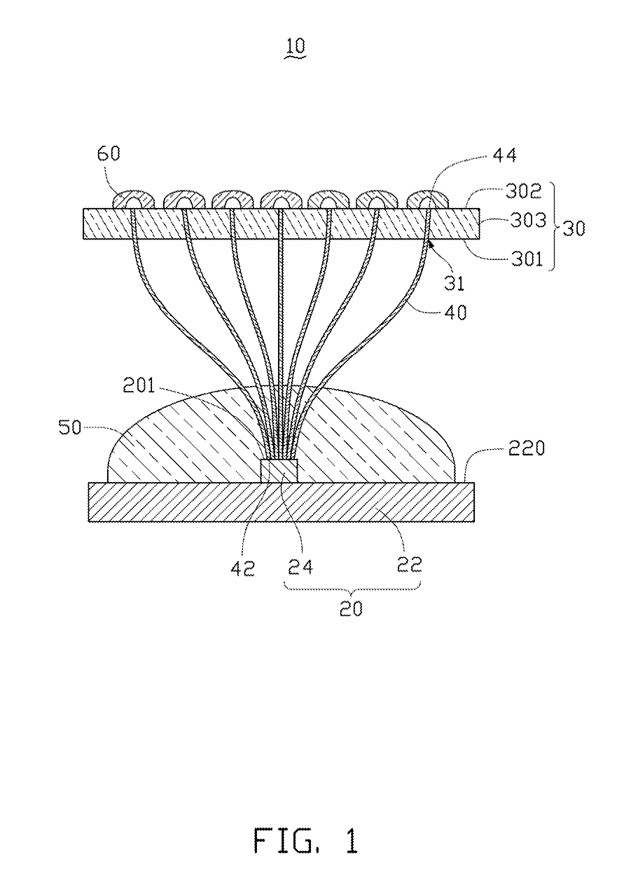

Referring to FIG. 1, a light source module 10 in accordance with an exemplary embodiment is provided. The light source module 10 includes a light source 20, a fixing plate 30, a plurality of fibers 40 and a plurality of light diverging elements 60.

In this embodiment, the light source 10 is an LED package. The light source 20 includes a substrate 22 and an LED chip 24 mounted on the substrate 22. The substrate 10 is flat and includes a top surface 220. The LED chip 24 is arranged on the top surface 220 of the substrate 20. The LED chip 24 is electrically connected with the substrate 22. The LED chip 24 includes a light outputting surface 201 parallel with the top surface 220 of the substrate 10.

The fixing plate 30 is arranged above the light outputting surface 201. The fixing plate 30 includes a bottom surface 301 facing to the light outputting surface 201, a top surface 302 opposite to the bottom surface 301 and a plurality of side surfaces 303 interconnecting the bottom surface 301 and the top surface 302. The fixing plate 30 defines a plurality of through holes 31 for the fibers penetrating. An aperture of each of the through holes 31 is matched with a dimension of each of the fibers 40.

Each of the fibers 40 includes a light inputting end 42 optically coupled to the light outputting surface 201 and a light outputting end 44 opposite to the light inputting end 42. The light inputting end 42 of each of the fibers 40 is connected with the light outputting surface 201 of the LED chip 24 via colloid. The light inputting ends 42 of the fibers 40 are tightly arranged on the light outputting surface 201 of the LED chip 24 to form a light beam. The light outputting end of each of the fibers 40 is inserted and received in the through holes 31 of the fixing plate 30. A distance between each two adjacent light outputting ends 44 of the fibers 40 is greater than a distance between each two adjacent light inputting ends 42 of the fibers 40. Such that the light outputting ends 44 of the fibers 40 are radially arranged to radiate the light generated by the light source 20. In this embodiment, the light outputting ends 44 of the fibers 40 are coplanar with the top surface 302 of the fixing plate 30.

Alternatively, the light outputting ends 44 of the fibers 40 can also be higher than the top surface 302 of the fixing plate 30. The fibers 40 are made of glass spinning materials or thermal plastic materials. The fibers 40 have an increasing length from a center thereof to a lateral periphery, that is the fibers 40 located outside have greater length than the fibers 40 located inside.

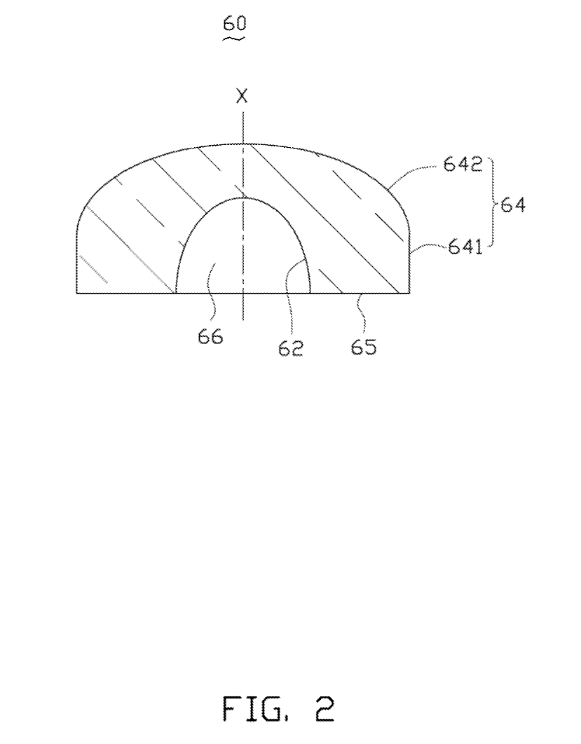

Referring to FIG. 2, the light diverging elements 60 are arranged on the top surface 302 of the fixing plate 30. The number of the light diverging elements 60 is equal to that of the through holes 31. Each of the light diverging elements 60 corresponds a through hole 31 and covers the through hole 31.

Each of the light diverging element 60 includes a light entering surface 62, a light illuminating surface 64 and an arranging surface 65 interconnecting the light entering surface 62 and the light illuminating surface 64. The arranging surface 65 is annular. The light entering surface 62 is located at an inner periphery of the arranging surface 65 and depressed toward the light illuminating surface 64. The light illuminating surface 64 includes a cylindrical surface 641 and a curved surface 642 connected with the cylindrical surface 641. The cylindrical surface 641 vertically extends upward from an outer periphery of the arranging surface 65. The light entering surface 62 and the top surface 302 of the fixing plate 30 are engaged together to form a receiving space 66. In this embodiment, both the light entering surface 64 and the light illuminating surface 64 are symmetrical relative to each center axis X. The light entering surface 62 is an ellipsoidal surface.

When the light source module 10 works, light generated by the light source 20 enters the light inputting ends 42 of the fibers 40 via the light outputting surface 201. The fibers 40 guides the light to each of the light outputting ends 44 received in each of the through holes 31 to form a plurality of point light sources. Light from the light outputting ends 44 enters each corresponding light diverging element 60 via the light entering surface 62. Part of light radiates out of the light diverging element 60 via the light curved surface 642, and part of light radiates out of the light diverging element 60 via the cylindrical surface 641.

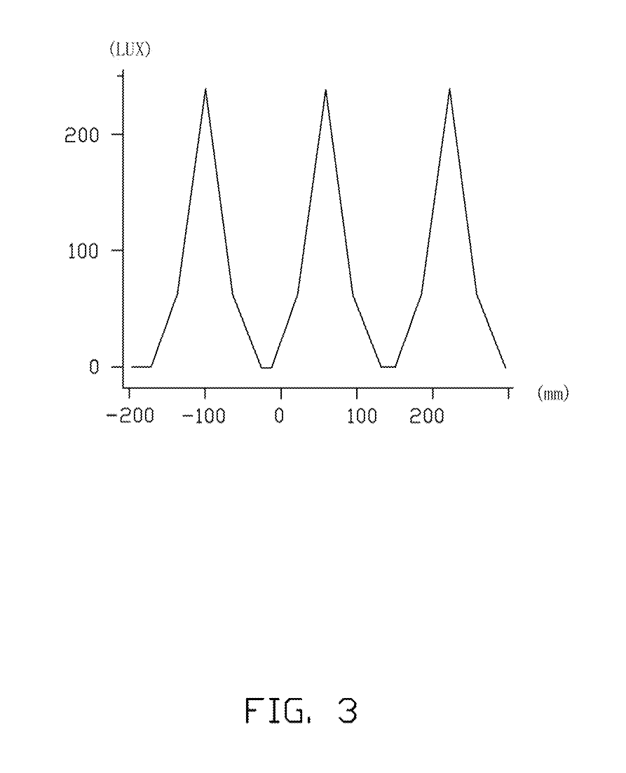

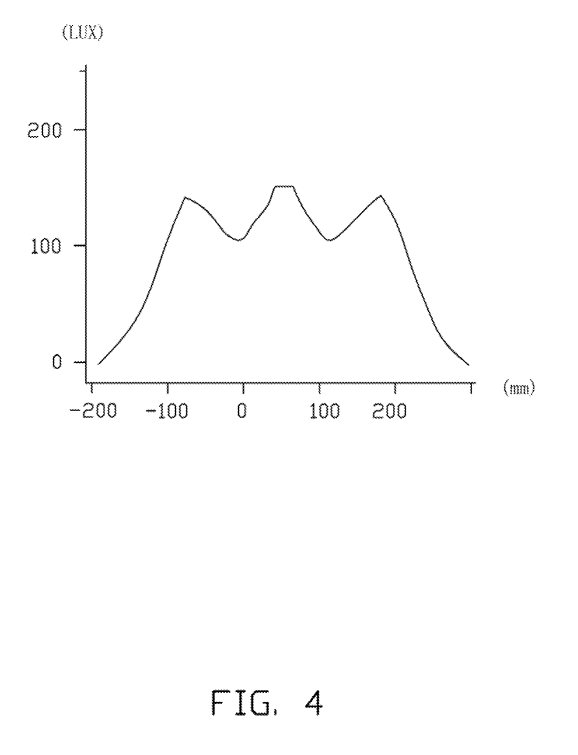

Referring to FIG. 3, when there is no light diverging element 60 arranged on the through holes 31 of the fixing plate 30, light from the light outputting ends 44 directly enters the air, the intensity of light located at a center of each of the light outputting ends 44 is much greater than that of located at a periphery of each of the light outputting ends 44, that is the light radiating out of the light source module 10 is not evenly distributed. Referring to FIG. 4, each of the light outputting ends 44 is covered by a light diverging element 60, and the light from the light outputting ends 44 is further diverged by the light diverging elements 60, such that the intensity of light located at a center of each of the light outputting ends 44 is substantially equal to that of located at a periphery of each of the light outputting ends 44. Accordingly, the light radiating out of the light source 10 is evenly distributed.

Since the distance between each two adjacent light outputting ends 44 is greater than the distance between each two adjacent light inputting ends 42, the intensity of light located at center areas of the light source 20 and the intensity of light located at periphery areas of the light source 20 are increased. Further, the light from the light outputting ends 44 is further diverged by the light diverging elements 60, such that the light radiating out of the light source module 10 is more evenly distributed.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light source module comprising:
a light source having a light outputting surface;
a fixing plate arranged above the light outputting surface of the light source;
a plurality of fibers, each of the fibers comprising a light inputting end optically coupled to the light outputting surface and a light outputting end opposite to the light inputting end, the light outputting ends of the fibers being inserted into the fixing plate, a distance between each two adjacent light outputting ends being greater than the distance between each two adjacent light inputting ends; and
a plurality of light diverging elements arranged on the fixing plate, each of the light diverging elements correspondingly covering one light outputting end of the fiber.

2. The light source module of claim 1, wherein the light source comprises a substrate and a light emitting diode (LED) chip, the substrate comprising a top surface, the LED chip being mounted on the top surface of the substrate and electrically connected with the substrate.

3. The light source module of claim 1, wherein the light inputting ends of the fibers are arranged on the light outputting surface via colloid to form a light beam.

4. The light source module of claim 1, wherein the light outputting ends of the fibers are radially arranged.

5. The light source module of claim 1, the light outputting ends of the fibers are coplanar with the top surface of the fixing plate.

6. The light source module of claim 1, wherein the light outputting ends of the fibers are higher than the top surface of the fixing plate.

7. The light source module of claim 1, wherein each of the light diverging elements comprises a concave light entering surface, a light illuminating surface opposite to the light entering surface and an arranging surface interconnecting the light entering surface and the light illuminating surface, both the light illuminating surface and the light entering surface are symmetrical relative to each center axis thereof

8. The light source module of claim 7, wherein the arranging surface is annular, the light entering surface is depressed from an inner periphery of the arranging surface toward the light illuminating surface.

9. The light source module of claim 7, wherein the light illuminating surface of the light diverging surface comprises a cylindrical surface and a curved surface connected with the cylindrical surface, the cylindrical surface extending upward from an outer periphery of the arranging surface.

10. The light source module of claim 1, wherein the fibers are made of glass spinning materials or thermal plastic materials.

11. The light source module of claim 1, wherein the fibers have an increasing length from a center thereof to a lateral periphery, the fibers located outside having greater length than the fibers located inside.

12. A light source module, comprising:
a light source having a light outputting surface;
a fixing plate arranged above the light outputting surface of the light source;
a plurality of fibers, each of the fibers comprising a light inputting end optically coupled to the light outputting surface and a light outputting end opposite to the light inputting end, the light outputting ends of the fibers being inserted into the fixing plate, the light inputting ends of the fibers are arranged on the light outputting surface via colloid to form a light beam, the light outputting ends of the fibers being radially arranged; and
a plurality of light diverging elements arranged on the fixing plate, each of the light diverging elements correspondingly covering one light outputting end of the fiber.

13. The light source module of claim 12, wherein the fibers have an increasing length from a center thereof to a lateral periphery, the fibers located outside having greater length than the fibers located inside, a distance between each two adjacent light outputting ends being greater than the distance between each two adjacent light inputting ends.

14. The light source module of claim 12, wherein the light source comprises a substrate and a light emitting diode (LED) chip, the substrate comprising a top surface, the LED chip being mounted on the top surface of the substrate and electrically connected with the substrate.

15. The light source module of claim 12, the light outputting ends of the fibers are coplanar with the top surface of the fixing plate.

16. The light source module of claim 12, wherein the light outputting ends of the fibers are higher than the top surface of the fixing plate.

17. The light source module of claim 12, wherein each of the light diverging elements comprises a concave light entering surface, a light illuminating surface opposite to the light entering surface and an arranging surface interconnecting the light entering surface and the light illuminating surface, both the light illuminating surface and the light entering surface are symmetrical relative to each center axis thereof

18. The light source module of claim 17, wherein the arranging surface is annular, the light entering surface is depressed from an inner periphery of the arranging surface toward the light illuminating surface.

19. The light source module of claim 17, wherein the light illuminating surface of the light diverging surface comprises a cylindrical surface and a curved surface connected with the cylindrical surface, the cylindrical surface extending upward from an outer periphery of the arranging surface.

20. A light source module, comprising:
a light outputting surface;
a fixing plate in optical communication with the light outputting surface;
a plurality of fibers that optically couple the light outputting surface and the fixing plate, the plurality of fibers comprising a light inputting end optically coupled to the light outputting surface and a light outputting end optically coupled to the fixing plate, a distance between adjacent light outputting ends being greater than a distance between adjacent light inputting ends; and
a plurality of light diverging elements arranged on the fixing plate, the light diverging elements being optically coupled to a corresponding light outputting end of the plurality of fibers.
